(19) United States
(12) Patent Application Publication
(10) Pub. No.: US 2025/0182360 A1
(43) Pub. Date: Jun. 5, 2025

(54) METHODS AND SYSTEMS FOR PERCEPTUALLY MEANINGFUL SPATIAL CONTENT COMPOSITING

(71) Applicant: DOLBY LABORATORIES LICENSING CORPORATION

(72) Inventor: Timo KUNKEL, Kensington, CA (US)

(73) Assignee: DOLBY LABORATORIES LICENSING CORPORATION, (US)

(21) Appl. No.: 18/852,425

(22) PCT Filed: Mar. 28, 2023
(86) PCT No.: PCT/US2023/016511

§ 371 Date: Sep. 27, 2024

Related U.S. Application Data
(60) Provisional application No. 63/362,166, filed on Mar. 30, 2022.

(30) Foreign Application Priority Data
Mar. 30, 2022 (EP) 22165451.0

(51) Int. Cl. G06T 11/60; G06F 40/106

(52) U.S. Cl. CPC G06T 11/60; G06F 40/106

(57) ABSTRACT

Approaches for generating metadata for content to be composited and rendered are described. These approaches can be used with the development and distribution of one or more web pages or other graphical user interfaces. For example, a web page developer can collect content to be composited together into a web page and invoke a set of APIs to generate the metadata for the content of the web page that will be composited; a metadata generation system receives the calls through the API and generates the metadata. The web page can then be distributed with the generated metadata which can be used to create the display of the web page with content that is perceptually modified based on the metadata about the individual elements on the web page and their spatial proximity.

### CROSS-REFERENCE TO RELATED APPLICATIONS

This application claims the benefit of priority to European Patent Application 22165451.0 filed Mar. 30, 2022 and U.S. Provisional Patent Application No. 63/362,166 filed on 30 Mar. 2022, each of which is incorporated by reference in its entirety.

### BACKGROUND

This disclosure relates to the field of content creation and content presentation on data processing systems such as computers, smartphones, televisions, and other electronic devices.

Content creation of movies and video content have used approaches that utilize metadata to adjust the appearance of content based on the metadata during the presentation (e.g., display) of the content. Dolby Vision is an example of these approaches. In these approaches, the content is created for a frame and presented. The content can be considered linear content in that one frame follows another frame over time. The frames are displayed sequentially over time; they are not composited together into a single image or displayable unit. Any metadata that is used during presentation to modify the presentation of content is created for a particular single frame or a series of frames over time.

US 2015/245004 A1 discloses a method and system for adaptively mixing video components with graphics/UI components, where the video components and graphics/UI components may be of different types, e.g., different dynamic ranges (such as HDR, SDR) and/or color gamut (such as WCG). The mixing may result in a frame optimized for a display device's color space, ambient conditions, viewing distance and angle, etc., while accounting for characteristics of the received data. The method includes receiving video and graphics/UI elements, converting the video to HDR and/or WCG, performing statistical analysis of received data and any additional applicable rendering information, and assembling a video frame with the received components based on the statistical analysis. The assembled video frame may be matched to a color space and displayed. The video data and graphics/UI data may have or be adjusted to have the same white point and/or primaries.

### SUMMARY OF THE DESCRIPTION

The invention is defined by the independent claims. The dependent claims concern optional features of some embodiments. Various approaches for generating metadata for content to be composited and using the generated metadata to render the composited content are described. These approaches can be used, for example, with the development and distribution of one or more web pages. In one embodiment, a web page developer can collect content (e.g., images in HDR or SDR and animation in HDR or SDR and text and user interface elements) to be composited together into a web page and invoke a set of APIs to generate the metadata for the content of the web page that will be composited; a metadata generation system receives the calls through the API and generates the metadata. The web page can then be distributed (e.g., to web browsers) with the generated metadata which can be used (e.g., by the web browsers or other content delivery system at render time) to create the display of the web page with content that is perceptually modified based on the metadata about the individual elements on the web page and their spatial proximity. These approaches can also be used for other types of displayable units.

In one embodiment, a method according to one aspect can include the following operations: receiving a set of elements containing content and data representing positions or positioning rules, on a displayable unit, of each of the elements in the set of elements; determining one or more types of content in each of the elements; generating a set of metadata, from the set of elements, the set of metadata for use in creating composited content from the set of elements on the displayable unit when the composited content is displayed, the set of metadata comprising (1) spatial data about the elements and (2) image metadata about at least some of the elements; and storing the generated set of metadata with an association to each of the elements. In one embodiment, the displayable unit is one of: (a) a page, sheet, folio, or other unit of content; or (b) a web page; or (c) a portion of or all of a screen of a display device or (d) content generated at least in part by a computer program. In one embodiment, the set of metadata also describes a temporal change of content over time. In one embodiment, the set of metadata is stored in a scalable vector graphics format such as a format that supports vector graphics for images. In one embodiment, a display device may be a planar display device or a non-planar device (such as a display device in an augmented reality or virtual reality headset). In one embodiment, the method can further include the operation of transmitting the set of elements and the generated set of metadata in response to a request for the web page, and wherein the data representing positions or positioning rules is contained in a description of the displayable unit in a hypertext markup language. Positioning rules can include rules, such as instructions or other data that defines how to determine positions of elements from data about, for example, an application's window (e.g., browser window), window scaling data or data about a display device or a combination of all or a subset of such data.

In one embodiment, the content of the elements can be different types of content. For example, the one or more types of content can comprise at least one of: (a) high dynamic range (HDR) image content; (b) standard dynamic range (SDR) image content; (c) text content; or (d) user interface content for use in receiving inputs from a user. Image content can be specified by pixel data (representations of a bitmap of an image) or by vector graphics data. In one embodiment, the spatial data can comprise vector based spatial data that defines approximate boundaries on the displayable unit of each of the elements in the set of elements.

In one embodiment, the image metadata can comprise color volume properties or image statistics for least some of the elements in the set of elements. In one embodiment, wherein the image statistics can be one or more of: maximum luminance of an image; minimum luminance of an image; mean luminance of an image; or median luminance of an image.

In one embodiment, the image metadata can comprise data about detected glare or data from which glare can be detected (depending on the viewing environment) in at least one of the elements in the set of elements, and the detected glare can be detected using one or more glare models. In one embodiment, the detected glare can be classified as one of: disability glare or discomfort glare.

In one embodiment, the image metadata can comprise a texture abstraction of at least one of the elements in the set of elements. The texture abstraction can be a mathematical expression of the image based on noise attributes and vector attributes. For example, the texture abstraction can be derived from a Fourier analysis based representation of the at least one of the elements in the set of elements. In one embodiment, the image metadata can include a quantized representation of at least one of the elements in the set of elements.

In one embodiment, an application programing interface (API) is used to cause the generation of the set of metadata, the API linking a metadata generation component in a data processing system with a web page creation software. The API can be called by the web page creation software to cause the generation of the set of metadata from a selected set of content that will be composited together to create the composited web page.

In one embodiment, a method according to a compositing aspect can include the following operations: receiving a set of metadata for use in creating composited content from a set of elements which are to be composited together for display in a displayable unit, the set of metadata comprising (1) spatial data about the elements and (2) image metadata about at least some of the elements; processing the set of metadata to determine how to modify one or more of the elements based on the set of metadata; modifying one or more of the elements based on the set of metadata; and rendering the composited content with the modified one or more elements to display the displayable unit on a display device. In one embodiment, the receiving can be in response to a request for a web page, and the set of metadata is received by a web browser. In one embodiment, the modifying based on the set of metadata can be performed: (a) before compositing the content; (b) after compositing the content; or (c) before and after compositing the content. For example, one set of elements can be modified before compositing and a subset of the modified elements can be modified again after compositing. The modifying can be based at least in part on the spatial data and the image metadata. In one embodiment, the spatial data can comprise vector based spatial data that defines approximate boundaries on the displayable unit of each of the elements in the set of elements, and the approximate boundaries are used to compute a distance between at least two elements in the set of elements. In one embodiment, the method can determine a distance, on the displayable unit, between a first element and a second element in the set of elements and determine a difference in an image metadata statistic (e.g., mean luminance values) between the first element and the second element; and then the method can modify one or both of the first element or the second element based on the determined distance and the determined difference. The image metadata can include data about detected glare (or data from which glare can be detected) which can cause the composited content to be modified to reduce the detected glare.

In one embodiment, the modifying can take into account one or more of: (a) an on screen and off screen status of content in the displayable unit; (b) display devices used to display the content in the displayable unit; (c) an ambient viewing environment surrounding a display device that displays the displayable unit; or (d) a viewing distance of a viewer of the displayable unit. For example, a viewer's field of view based on the viewing distance can be used to determine when elements are within a field of view and may need to be modified due to large differences in image metadata statistics (e.g., a dim image next to a bright image) in the same field of view.

The aspects and embodiments described herein can include non-transitory machine readable media that can store executable computer program instructions that when executed cause one or more data processing systems to perform the methods described herein when the computer program instructions are executed. The instructions can be stored in non-transitory machine readable media such as in dynamic random access memory (DRAM) which is volatile memory or in nonvolatile memory, such as flash memory or other forms of memory. The aspects and embodiments described herein can also be in the form of data processing systems that are built or programmed to perform these methods. For example, a data processing system can be built with hardware logic to perform these methods or can be programmed with a computer program to perform these methods.

The above summary does not include an exhaustive list of all embodiments and aspects in this disclosure. All systems, media, and methods can be practiced from all suitable combinations of the various aspects and embodiments summarized above and also those disclosed in the detailed description below.

### BRIEF DESCRIPTION OF THE DRAWINGS

The present invention is illustrated by way of example and not limitation in the figures of the accompanying drawings in which like references indicate similar elements.

FIG. 1A shows an example of a displayable unit (e.g., a web page) that includes content that was composited or assembled from separate content elements, such a separate images and text and other types of content.

FIG. 1B shows an example, according to one embodiment, of a content creation and distribution system, such as a system that creates and distributes a set of web pages from one or more web servers.

FIG. 2A is a flowchart that shows a method, according to one embodiment, for creating metadata for content that is to be composited and rendered based upon the created metadata.

FIG. 2B shows an example, according to one embodiment, of a content creation system that creates metadata for content that is to be composited and rendered based on the created metadata.

FIG. 2C shows an example, according to one embodiment, of a method to create metadata for a displayable unit (e.g., a web page) and then composite and render the displayable unit; the method in FIG. 2C may be performed by several different data processing systems or by a single data processing system.

FIG. 3A is a flowchart that shows a method, according to one embodiment, to generate spatial metadata and image statistics metadata.

FIG. 3B is a flowchart that shows a method, according to one embodiment, to generate spatial metadata.

FIG. 4A shows an example, according to one embodiment, of the creation of a texture abstraction of an image (of a flower in front of a bokeh background).

FIG. 4B shows an example, according to another embodiment, of a quantized and segmented abstraction of an image.

FIG. 5A is a flowchart that shows a method, according to one embodiment, to composite and render a displayable unit using generated metadata.

FIG. 5B is a flow diagram that shows a method, according to one embodiment, to composite and render a displayable unit using pre-generated metadata and also metadata that is generated at render time by the device performing the compositing.

FIG. 5C shows an example, according to one embodiment, of a method to composite and render a displayable unit that includes composited content.

FIG. 6A shows an example, according to one embodiment, for applying generated metadata when compositing.

FIG. 6B shows an example, according to one embodiment, for applying generated metadata to compensate for detected glare in a perceptually meaningful way during compositing.

FIG. 6C shows another example, according to one embodiment, of the application of generated metadata to modify content during compositing.

FIG. 6D shows an example, according to one embodiment, of the application of generated spatial and temporal metadata to modify content during compositing of a displayable unit that changes over time.

FIG. 7 shows an example of a data processing system that can be used to implement one or more of the embodiments described herein.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

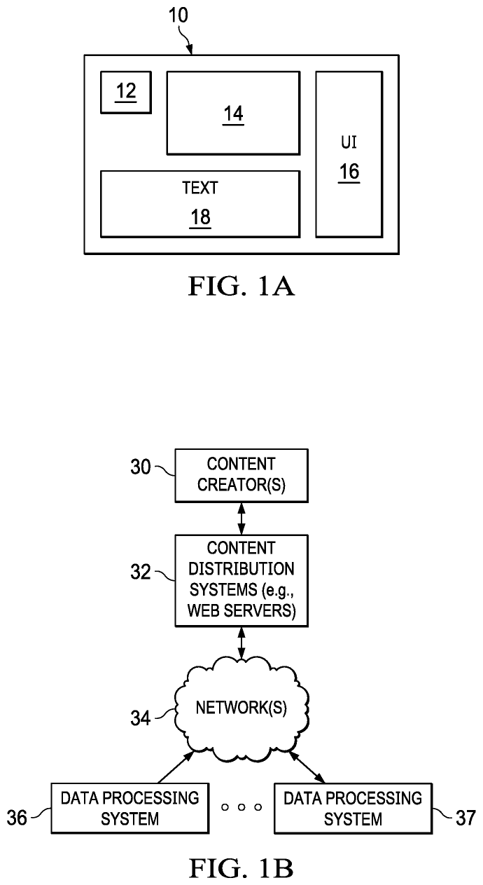

The embodiments described herein can create metadata for content elements that will be assembled or composited into a displayable unit, and when a data processing system composites the content into the displayable unit the data processing system can modify that content based upon the created metadata so that the compositing can be considered to adjust the appearance of at least some of the content for the entire displayable unit. The displayable unit can be, for example, a web page that is composited at display time (e.g., on a client web browser) from content that is often from different sources and of different types. The content is composited into a spatial arrangement on the displayable unit based upon data that defines the spatial arrangement (e.g., HTML or CSS in a web page). The content modification can take this spatial arrangement into account to modify the content based in part on the spatial arrangement and in part of image metadata or other content metadata. FIG. 1A shows an example of a displayable unit that is a web page. The web page 10 includes an image 12, an image 14, text 18, and a user interface panel 16 that contains selectable commands that a user can select to cause the web page to perform an operation. The images 12 can have different types of content; for example, they can be high dynamic range (HDR) image content or standard dynamic range (SDR) image content (or video content that may be either HDR or SDR). The images may be stored or represented in pixel data format (often in compressed form) or may be represented by vector graphics data (and hence may be referred to as vector graphics based imagery). The text can be adjustable in size. While this disclosure will often use a web page as an example of a displayable unit, the embodiments described herein can also work with other types of displayable units, such as: (a) a page, sheet, folio, or other unit of content; or (b) a portion of or all of a screen of a display device or (c) content generated at least in part by a computer program or an electronic device. The display device can be a computer display or smart phone display or a TV display, displays in virtual reality or augmented reality headsets or other known and future display devices, and may use a planar display screen (e.g., an LCD or OLED) or a curved or non-planar display.

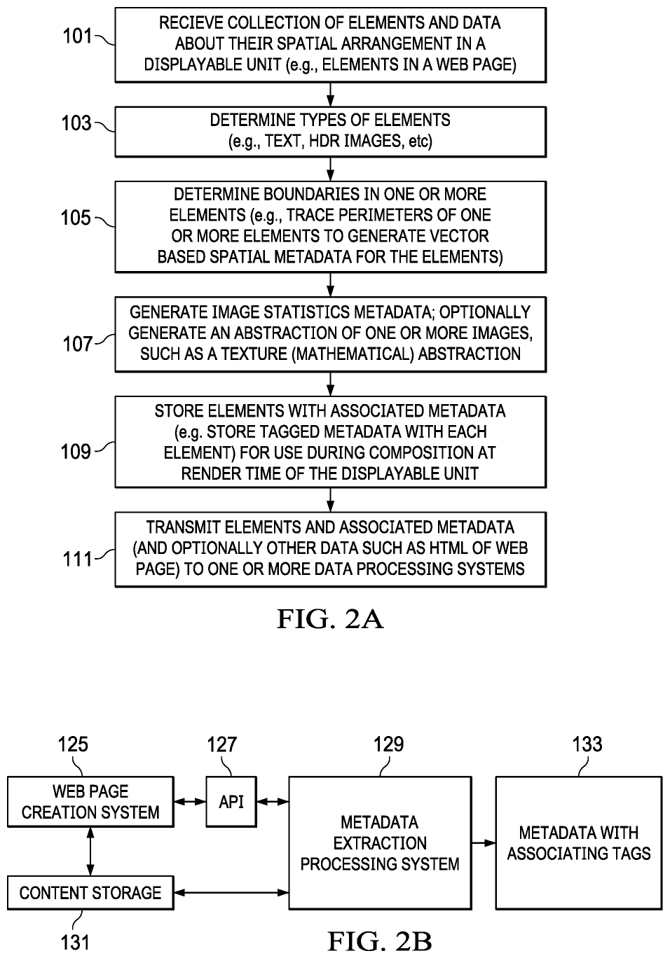

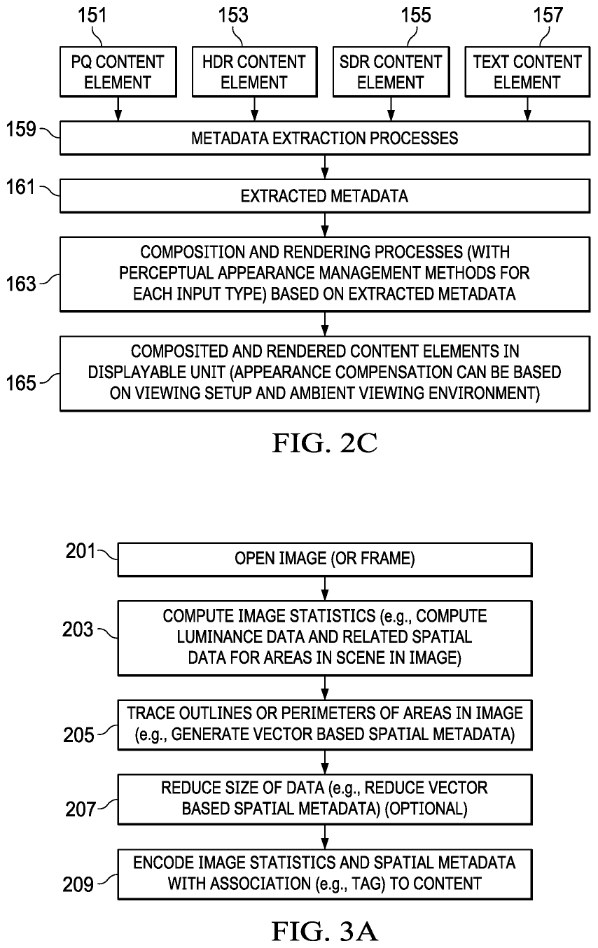

In many embodiments, the displayable unit is created by one or more content creators and then distributed to users who operate data processing systems (such as desktop computers, other types of computers, smart phones, wearable devices, gaming systems, entertainment systems such as televisions, consumer electronic devices, etc.) to view and interact with the displayable unit. FIG. 1B shows an example of such a distribution which may be used for web pages. The one or more content creators 30 can create one or more web pages to be distributed by one or more content distribution systems 32 which may be conventional web servers that transmit web pages to web browsers (on client systems) that request the web pages. The one or more content distribution systems 32 can be coupled to one or more networks 34 to receive the requests for web pages from data processing systems 36 and 37 that are also coupled to the one or more networks 34. The data processing systems 36 and 37 can be computers or other devices that execute a web browser (or other content consumption system); these web browsers can request a web page through the networks 34 and receive the web page from the networks 34. The web page can include conventional content (e.g., images, text, user interface (UI) elements, etc.) and also the metadata described herein for use during compositing of the web page. In one embodiment, the one or more content creators 30 can use the method shown in FIG. 2A and the system shown in FIG. 2B to create the displayable unit with such metadata.

The method shown in FIG. 2A can begin in operation 101 by receiving a collection of elements (e.g., images 12 and 14 and text 18 and UI 16 in FIG. 1A or content elements 151, 153, 155, and 157 in FIG. 2C) that will be composited into a single displayable unit and by receiving data about their spatial arrangement (e.g., two dimensional positioning or arrangement/layout or other positioning information (such as positioning rules from which the final positions are determined) in the displayable unit. The spatial arrangement data may specify actual positions or positioning rules (e.g., CSS layout rules) that are dynamically used at display time (based upon, for example data about the application's window and scaling data and display device data about the size of the display) to determine the actual positions. In one embodiment, the spatial arrangement may be described in HTML (hypertext markup language) or similar markup language formats or CSS (cascading style sheets), etc. In some embodiments, the method may include operation 103 in order to classify the different types of content; this may be necessary so that each different type of content can be processed according to its type. For example, a movie in HDR may require the generation of temporal metadata (described below), while a displayable unit that contains only content that is static over time should not require temporal metadata. Operation 103 may not be needed in those cases where the types are specified by data associated with the displayable unit (e.g., the web page's HTML specifies the type of content for the different content elements).

In operation 105 in FIG. 2A, the method can determine the one or more boundaries associated with each content element. For example, as described further below, a data processing system can trace the perimeters of one or more elements (or content within each of the one or more elements) to generate spatial metadata. This spatial metadata can be vector based metadata that defines position data using a vector format (e.g., a set of x, y Cartesian coordinates such as a pair of Cartesian coordinates). In certain embodiments, the exterior perimeter of at least some content elements may need to be traced when the received data associated with the content element (from operation 101) does not define the exterior perimeter. In one embodiment, operation 105 may define perimeters of portions of content within a content element (such as portions of an image within the image). These different portions may be classified by using quantized thresholds described further below (e.g., threshold values in luminance values) to segment content within a content element such as a single image.

In operation 107 in FIG. 2A, the method can generate image statistics metadata. In one embodiment, operation 107 can be performed before operation 105 and be used to segment the different portions of each image (in order to segment the different portions based on the quantized threshold luminance values). The generated image statistics metadata can be used, as described further below, to determine how to modify each image based upon the image statistics metadata and the spatial metadata. Operation 107 can also optionally include generating an abstraction of one or more images. Examples of such abstractions (e.g., texture and quantized abstractions) are provided below. In one embodiment, the abstractions can be mathematical descriptions of an image that retain no per pixel data and are much reduced in storage size relative to pixel data for the complete image. These abstractions can also be used to determine how to modify each image based upon the abstractions and the spatial metadata.

In operation 109 in FIG. 2A, the method can store content elements and associated metadata (e.g., extracted from the elements and their spatial and temporal arrangement) for use during composition at render time when the displayable unit containing all of the content elements is displayed at a client system. Then, the components of the displayable unit (including the content elements and the associated metadata and other data such as HTML) can be transmitted in operation 111 to one or more other data processing systems. These components can then be used at such data processing systems to composite (e.g., assemble the components into a single web page) and render the displayable unit (e.g., the web page) onto a display device such as an organic light emitting diode (OLED) display device; the display devices can be either planar devices or non-planar (e.g., spherical like screens).

An example of a system for performing the method in FIG. 2A is shown in FIG. 2B. This system in FIG. 2B is based on a web page embodiment in which the displayable unit is a web page. The system includes a web page creation system 125 that is coupled to content storage 131; the content storage can store the collection of content items on the displayable unit, the HTML of the web page and also the extracted metadata that will be used when the displayable unit is composited. The web page creation system 125 can be based on conventional web page authoring software packages that are known in the art. The system also includes a metadata extraction processing system 129 that can perform the one or more embodiments and methods described herein (e.g., the method shown in FIG. 2A, etc.) to generate metadata that is used during compositing. The metadata extraction processing system 129 can operate with the web page creation system 125 through an application programming interface (API) 127 that allows the two different software components (the web page creation system 125 and the metadata extraction processing system 129) to operate and communicate to cause the metadata extraction processing system to generate the metadata, for each content element, for use during compositing. Once such metadata is generated, it can be stored as metadata 133; the stored metadata 133 can be stored, in one embodiment, with tags that associate each piece of metadata with the appropriate content element; in other words, the tag for a metadata component can specify the identity of the content element described by or associated with the metadata component. The metadata can also or alternatively be stored with the content (e.g., appended to its corresponding content). The system shown in FIG. 2B allows a content creator to invoke the metadata extraction processing system 129 through calls in the API and in turn the metadata extraction processing system 129 can use the method described herein to generate metadata for each content element, without requiring the content creator to generate manually the metadata. This simplifies the process of creating a web page that can be composited using the metadata described herein. The calls through the API can allow for the generation of the metadata once all of the content elements have been selected and positioned/arranged on a web page.

A further example of a method for generating metadata during the creation of a displayable unit is shown in FIG. 2C. This example includes four different types of content elements which include a PQ (perceptual quantizer) encoded content element 151, a Hybrid Log Gamma encoded HDR content element 153, a SDR content element 155, and a text element 157. Other types of content elements may also be included into a displayable unit, such as vector graphics or geometric shapes/areas and backgrounds, and these other types of content elements can be processed as described herein. These content elements may be composited together to create a web page that is displayed a web browser on a client data processing system after the client system downloads the components of the web page from one or more servers. In operation 159, a metadata extraction process generates metadata from each content individual element using one or more embodiments described herein; the metadata extraction process can be performed by the system 129 shown in FIG. 2B. In a typical embodiment, operation 159 analyzes each image, using image statistics, to generate the image metadata about the image; this analysis creates the metadata although alternative embodiments may use metadata that already accompanies the image (so the metadata is present with the original image). The generated metadata may include vector based spatial metadata about each content element and image statistics of each content element and also spatial metadata with image statistics within each content element; further, an abstraction of each image may also be created as additional metadata for each image. The metadata extraction process in operation 159 produces the extracted metadata 161 which can be stored with the content; in one embodiment, the metadata is tagged with an identifier that identifies the associated content described by the metadata. After the extracted metadata 161 is stored a data processing system (e.g., a client data processing system with a web browser) can perform the composition and rendering processes 163 based on the extracted metadata 161; these composition and rendering processes 163 can perform the methods described herein to modify and composite and render the collection of content elements based on the metadata 161. These composition and rendering processes 163 can then produce the composited and rendered content elements in the displayable unit 165 that contains the modified content elements. The displayable unit can display the content elements after they have been modified based on the metadata 161 and the viewing setup (e.g., number and types of monitors) and ambient viewing environment (e.g., dark viewing environment or a bright viewing environment). Further disclosure of aspects of FIG. 2C are provided below with respect to the composition and rendering operations.

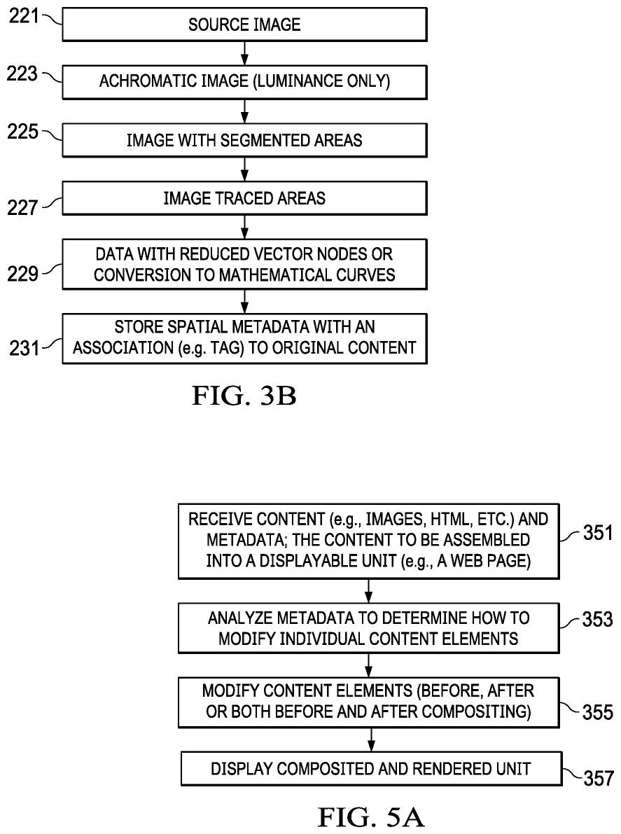

An embodiment of a metadata generation method is shown in FIG. 3A. In this method, spatial metadata and image statistics metadata can be generated and encoded for each content element, such as an image (e.g., an SDR image), in a displayable unit (e.g., a web page). In operation 201, a data processing system can open an image or frame of content corresponding to a content element in the displayable unit. For example, a metadata processing component (system 129 in FIG. 2B) can open a content element and then process the content element in order to extract metadata. In operation 203, the data processing system can compute image statistics for the image (or frame); for example, in one embodiment, the system can compute luminance data [e.g., average luminance, median luminance, maximum luminance, minimum luminance, etc. based on the image metadata for the content element] and other image metadata statistics and can compute spatial data for areas in a content element as described herein. These computed image statistics can be used to segment the image into different areas or segments based on the computed statistics. Each segment can be based upon quantized levels of luminance in one embodiment so that contiguous pixels having luminance values within each quantized bucket or level of luminance (L) values are classified within a segment (e.g., one quantized level for pixels having L less than 0.1 nits, another quantized level for pixels having L greater than 600 nits, and another quantized level for pixels having L between these two levels). The representations of L may also be expressed in an SI unit of cd/m². Each segment can be regarded as being defined by a pixel threshold boundary. Numerous techniques are known in the art to segment an image of pixels; see for example published PCT application PCT/US2020/062942 (WO 2021/113400).

Once the areas are identified, their boundaries can be determined. For example, in operation 205, the data processing system can determine the boundaries of each segmented area in the image by tracing the outlines or perimeters of areas in the image. The tracing can produce a set of vector based spatial metadata that defines the outline or perimeter of each segmented area, and image statistics for each segment can also be included with this vector based spatial metadata. The outlines can be traced by identifying edges (that define the perimeter) and connecting them with lines; the points at the end of each of the lines describe a vector. Alternatively, piecewise curve fitting following the pixel threshold boundaries can be used; techniques are known in the art to perform this piecewise curve fitting. See, for example, the following literature that describes curve fitting: Michael Plass & Maureen Stone. 1983. Curve fitting with piecewise parametric cubics. SIGGRAPH Comput. 17, 3 (July 1983), 229 239. DOI: https doi.org/10.1145/964967.801153. Wenping Wang, Helmut Pottmann, and Yang Liu. 2006. Fitting B spline curves to point clouds by curvature based squared distance minimization. ACM Trans. Graph. 25, 2 (April 2006), 214-238. DOI: https doi.org/10.1145/1138450.1138453. Gerald Farin. 1993. Curves and surfaces for computer aided geometric design (3rd ed.): a practical guide. Academic Press Professional, Inc. In an alternative embodiment, at least some of the segments or areas can be manually selected. Once the outlines or perimeters are defined, an embodiment of the method in FIG. 3A may attempt, in operation 207, to reduce the size of the spatial metadata; this can be done, in one embodiment, by reducing the number of nodes along the perimeter (e.g., combining two lines into one line that approximates the two lines). Once the spatial metadata and the image statistics have been generated, they can be encoded and stored in operation 209 with an association to the corresponding image from which the metadata was created; the association can be a tag that identifies that image. The metadata may be stored separately from the image and include the tag so that the compositing processes can locate the appropriate metadata for the image. In one embodiment, the metadata can be stored as a markup language or in a scalable vector graphics format (which is already supported by web browsers and GPU renderers).

FIG. 3B shows another example of how an image that is one of the content elements to be composited can be processed to generate metadata such as spatial metadata and image statistics. The source image is received in operation 221 and converted into a black and white image 223. Then, the image can be quantized in operation 225 to generate a set of segments based on the quantization (e.g., a luminance quantization as described above). The metadata processing system can then trace, in operation 227, each of the segments to produce a set of vectors that describe the boundary or perimeter of each segment. The metadata processing system can then, in operation 229, reduce the spatial metadata and store the spatial metadata in operation 231.

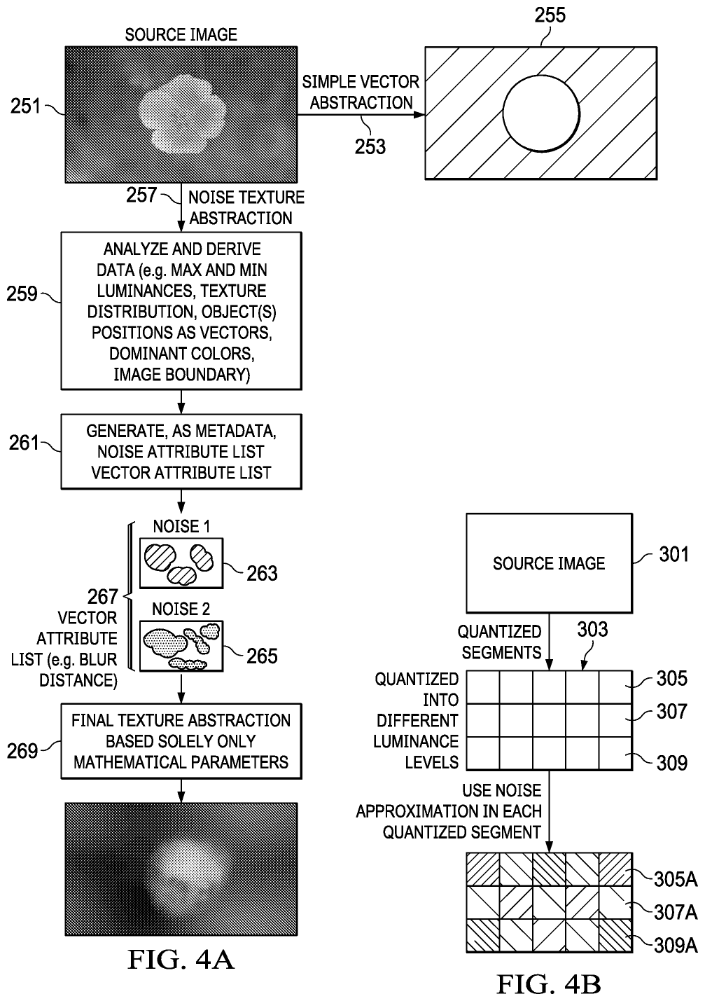

Each image in the set of content elements may be described by an abstraction that can be processed when compositing the displayable unit. The abstraction can provide a statistical representation of the image for purposes of compositing and rendering (for perceptually meaningful content modifications based on the composited displayable unit) while requiring much less storage space than a stored version of the image. The abstraction can be a mathematical representation that describes the image without requiring data for each individual pixel. FIGS. 4A and 4B provide two examples of such abstractions for images that can be used in one or more embodiments.

An abstraction of an image can use textures or noise textures, and this abstraction can successfully capture data that is sufficient for compositing and still have a small storage (and transmission) “footprint”. The example shown in FIG. 4A uses a noise texture abstraction to generate an abstraction of the image that can be saved as metadata (referred to as abstraction metadata) that is used during compositing and rendering processes. This abstraction metadata can then be processed during compositing without using the actual image to make decisions about how to modify content (in the image or other content surrounding the image) during the compositing and rendering. In one embodiment, each segment or area of an image can be associated with a texture property that is mathematically defined (e.g., defined by 1/f noise, where f is a frequency of pixel data). Examples of noise textures can be created based on the techniques and approaches described in the following published paper: Kunkel, T. and Daly, S. (2020), 57-1: Spatiotemporal Noise Targets Inspired by Natural Imagery Statistics. SID Symposium Digest of Technical Papers, 51:842-845. (see https://doi.org/10.1002/sdip.14001). In one embodiment that uses these approaches, a random seed image is selected (or a varying random seed is selected) and then a process, based upon a selected alpha (α) value, generates frequency components that produce different two dimensional noise texture images. In one embodiment, a metadata processing system may select larger alpha values (e.g., α=4 or 5) for HDR images than non-HDR images; natural imagery (e.g., an image of a forest or river valley) may benefit from alpha values in the range of 2 to 3. The alpha value affects the frequency distribution of the noise.

As shown in FIG. 4A, an image 251, which is one of the content elements to be composited into a displayable unit such as a web page, can be processed using a noise texture abstraction process 257 into a final texture abstraction 269. The final texture abstraction 269 can provide a more refined representation of the image than a simple vector representation 255 created by a simple vector abstraction process 253 which uses threshold maps as described above in connection with FIGS. 3A and 3B. The noise texture abstraction process 257 can start, in one embodiment, with a vector based mask (from the vector abstraction process 253) so that different portions of the image can be processed separately, based on the vector based mask, using the noise texture abstraction process 257. The noise texture abstraction process 257 can begin with an analysis 259 that derives a set of data that is used in the noise texture abstraction process 257; this data can include luminance data (e.g., minimum and maximum L), texture distribution data, object position data (e.g., positions of significant objects, where the positions are expressed as vectors), data about dominant colors, and image boundary data. The noise texture abstraction process 257 can then generate, in operation 261, a noise attribute list and a vector attribute list 267. The noise attribute list can identify the noise textures, such as noise textures 263 and 265, that have been created as representative of one or more portions of the image; the vector attribute list can identify the positions of each of the noise textures to be used to represent the one or more portions of the image. These noise textures can be based on the segment of the image they will replace so that, for example, the minimum and maximum luminance of the noise texture is about the same as the minimum and maximum pixel values in the segment of the image that will be represented by the noise texture in the generated metadata. Hence, a texture abstraction can include a plurality of different noise textures that are composited together to represent the entire image. The storage (and transmission) size of a texture abstraction of an image can be significantly less than the actual image and can also be more quickly processed at composition and render time; moreover, the texture abstraction can be tailored to provide enough data (but not too much data) for the composition and rendering process.

Another approach to create an abstraction of an image is to divide the image into segments and quantize each of the segments based on the image metadata within each segment. For example, an average luminance value within each segment can be used with a set of thresholds (e.g., three thresholds of: less than 0.1 nits, greater than 0.1 nits and less than 600 nits, and greater than 600 nits) to classify each segment into one of the quantized levels. This approach is shown in FIG. 4B. The source image 301 is one of the content elements that is to be composited and rendered in a displayable unit such as a web page. The source image 301 is segmented into segments, such as segments 305, 307 and 309, and each segment is then quantized into one of the different luminance levels. Then, a noise abstraction texture can be applied to each segment, such as segments 305A and 307A and 309A; these noise abstraction textures can be based on the approach described in connection with FIG. 4A. While the segments in FIG. 4B are rectangular, other shapes of the segments can be used in one or more embodiments. The shapes, for example, of each segment can be defined by arbitrary perimeters that are based on image statistics as described above (e.g., see description of operation 203 above).

The examples shown in FIGS. 3A, 3B, 4A, and 4B can create spatially local metadata within an image. This spatially local metadata can specify the position of each segment (and its boundaries) within the image and also specify one or more image statistics (e.g., mean luminance, maximum luminance, minimum luminance, color related properties such as dominant color, color statistics, etc.) that describe each segment. Spatially local metadata within an image can help when a designer adjusts the image by, for example, cropping the image. Consider the case of an image that includes some dark content (e.g., a forest) and the Sun, which would normally be a very high luminance (e.g., 10,000 nits); for example, the image may be a photograph of the forest with the Sun over the forest on a bright, cloudless day. If the image is cropped to exclude the Sun (e.g., either during the process of designing the displayable unit such as a web page or during composition when a screen size adjustment or dynamic web layout or animation causes the cropping), the spatially local metadata can allow a system (e.g., a composition and rendering system) to use only the spatially local metadata within the cropped image (which excludes the Sun). This selection of only spatially local metadata within the cropped image will change the maximum luminance value and will likely cause a change in how the cropped image (or other images near the cropped image) is modified during the compositing and rendering. In one embodiment, metadata nodes (having such spatially local metadata) can be spatially distributed over the entire image (e.g., in a grid) to insure adequate coverage of the image. Such metadata can include descriptions of the spatial tone distribution in the image. In one embodiment, the methods described in U.S. Pat. No. 10,977,764 (assigned to Applicant Dolby Laboratories Licensing Corporation) may be used for such distributed metadata nodes.

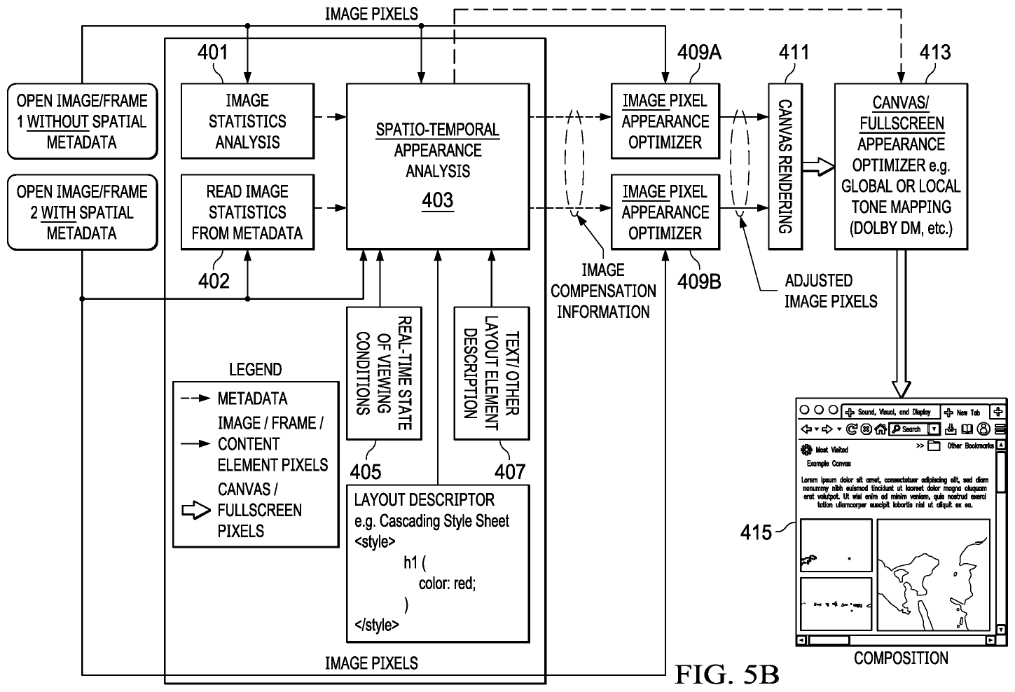

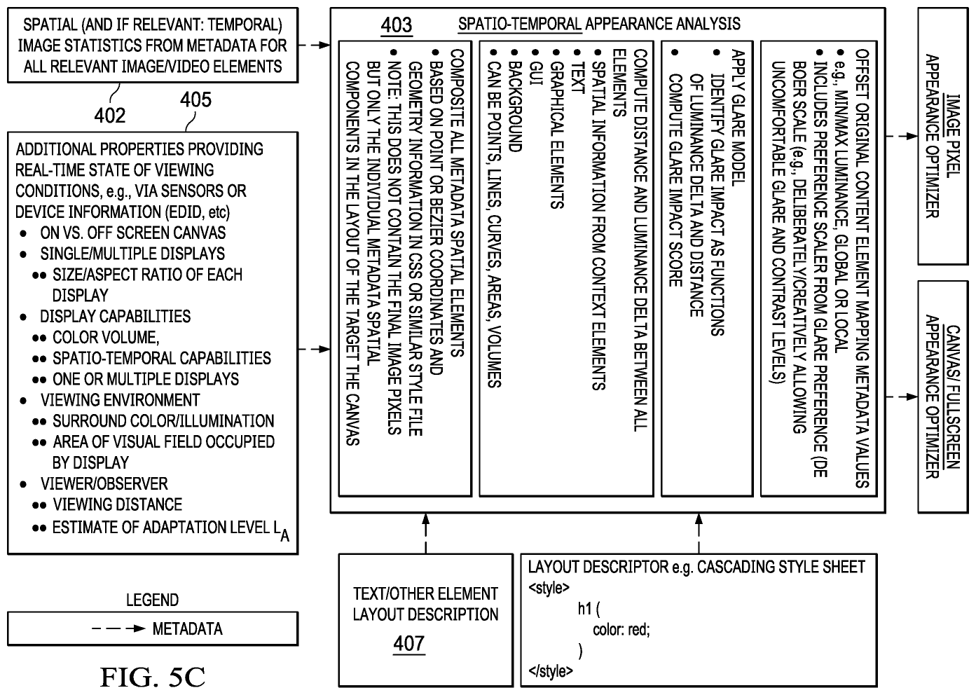

Once the metadata for the composition and rendering processes is created and saved (e.g., in operation 109 in FIG. 2A), the content elements and the metadata can be used by a data processing system that composites and renders the displayable unit. FIG. 5A provides a simplified version of a method that can be performed by such a data processing system. In operation 351, the data processing system can receive the content elements for the displayable unit and also receive the generated metadata so that the content elements can be composited in a perceptually meaningful way that is based on the metadata. In operation 353, the data processing system analyzes the metadata to determine how to modify one or more of the content elements; this analysis can include calculating distances between portions of content elements and analyzing the metadata in view of these distances. The calculated distances can be compared to threshold values for distance that are based on field of view of a user. If the distances exceed such a field of view, no modification may be required. In operation 355, the data processing system modifies one or more of the content elements. As explained further below, the modifying can be before content elements are composited or after they are composited or both before and after. The modifications can be based in part on the spatial arrangement of content elements on the displayable unit and based in part of image metadata and temporal metadata. Once the displayable unit has been composited and rendered into a frame buffer, it can be displayed in operation 357.

FIGS. 5B and 5C provide a more detailed example of a method and pipeline for compositing and rendering a displayable unit based upon the generated metadata (e.g., the generated metadata stored in operation 109 in FIG. 2A). Referring now to FIG. 5B, for the content elements that have associated metadata that has been previously generated, the method reads the stored metadata in operation 402. The example in FIG. 5B includes a situation in which at least one of the content elements lacks previously generated metadata. That content element can be processed, in operation 401 during the compositing process, to generate metadata; operation 401 can include any one or more of the methods described above to generate metadata, such as the methods shown in any one or FIG. 2A, 2C, 3A, 3B, 4A or 4B. All of the metadata can then be provided to operation 403 which analyzes a set of inputs, which include the metadata (from 401 and 402), the content in the content elements, and the layout description 407 (e.g., HTML or CSS or other formats that describe the arrangement of the various content elements on a displayable unit), to determine how to modify one or more content elements based upon the inputs. The inputs can also include current data (e.g., real time data) about the state of the viewing condition 405 (e.g., types of displays, ambient light conditions surrounding the one or more displays, etc.). Generally, the appearance analysis in operation 403 attempts to determine how the physical arrangement and layout of the content will affect the perceptual appearance of the content elements. Operation 403 provides one or more outputs to appearance optimizers 409A and 409B that modify one or more images based upon the outputs from operation 403; multiple appearance optimizers allow for parallel processing. In an alternative embodiment, there may be a single appearance optimizer. The adjusted pixel values are then provided to a renderer 411 to create the composited page or other displayable unit 413 which is displayed 415 on one or more display devices (e.g., an OLED display or a VR or AR headset, etc.).

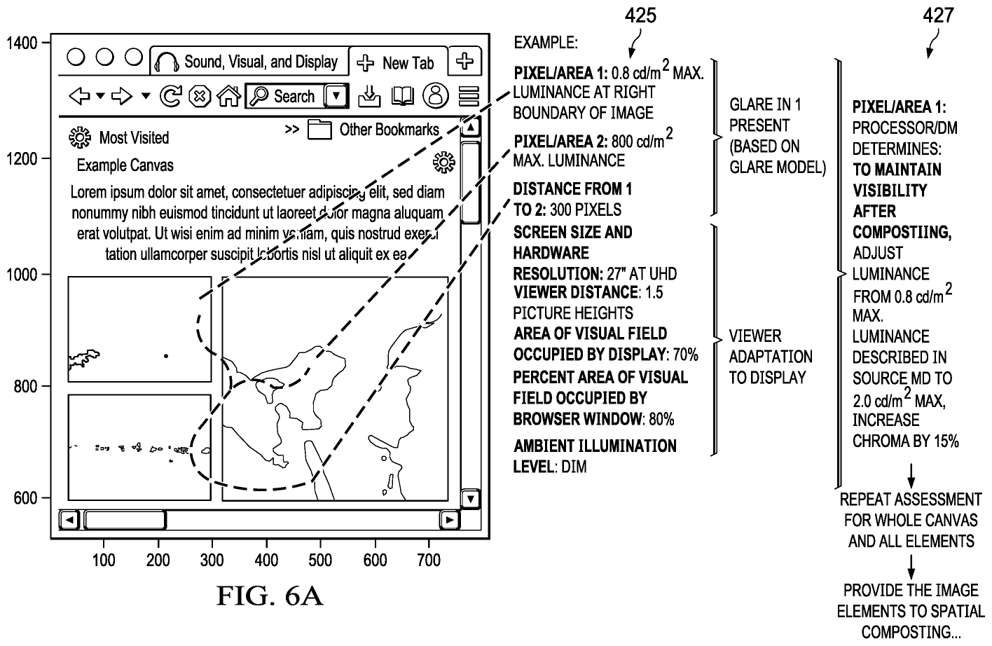

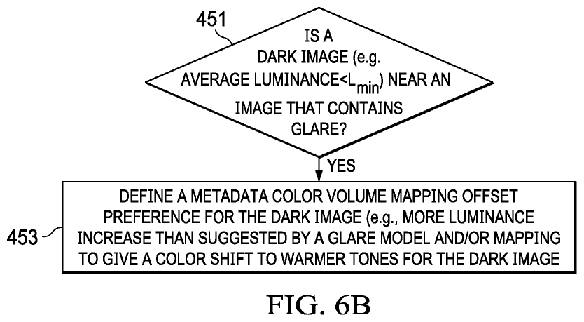

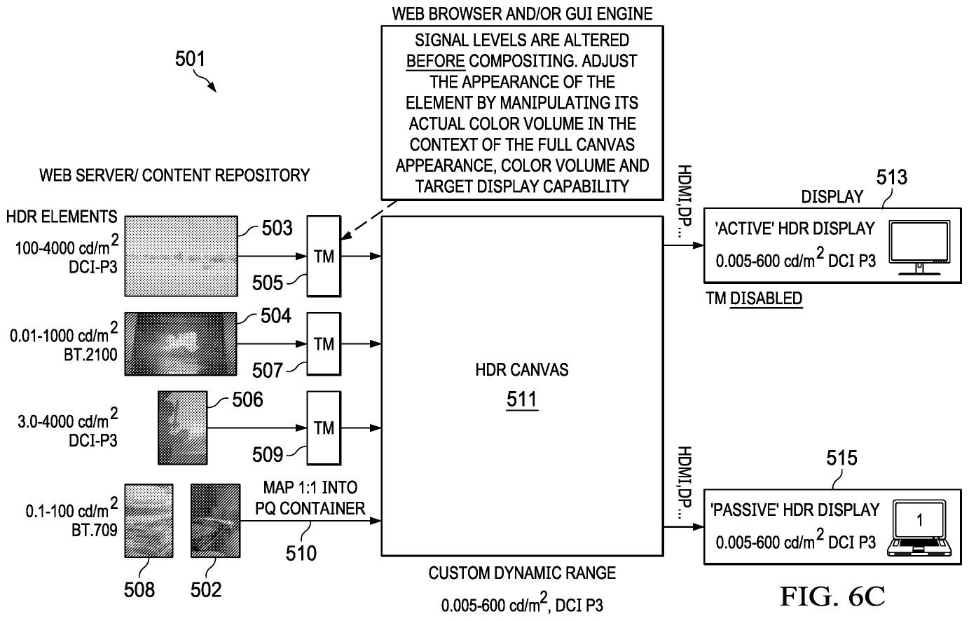

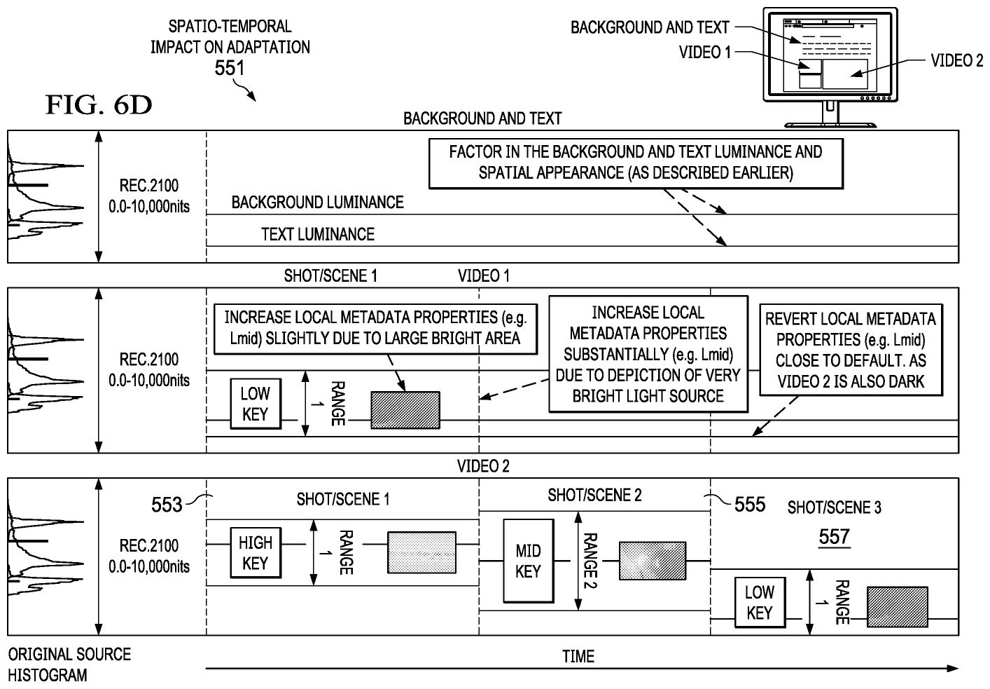

FIG. 5C shows more detail with respect to operation 403. As shown in the example of FIG. 5C, the data processing system can composite the spatial metadata (but not the content elements themselves) onto the displayable unit during operation 403 and then compute distance and luminance difference values between all of the elements (represented by the spatial metadata) for the given physical layout on the displayable unit. In effect, operation 403 can be considered a preliminary compositing operation using the spatial metadata to place the spatial metadata (but not the actual content elements) on the displayable unit; this compositing occurs before the compositing that uses the actual content elements in operation 411. Operation 403 can also apply one or more glare models which are known in the art. Then operation 403 can compute modifications such as adjusts or offsets; for example, the content element may include mapping values to ensure all pixel values are between preselected maximum and minimum luminance values, and these mapping values can be adjusted by operation 403 based upon the appearance analysis in operation 403. The modifications can be to individual image content elements before compositing or to a set of image content elements after compositing or both. In addition, the appearance of text may be adjusted if, for example, the contrast ratio of the text to its background is not within a desired range; generally, text should have a minimum contrast of about 4:1 and the maximum contrast should not exceed about 10:1 in one embodiment. Text which has too much contrast relative to its background can cause visual discomfort and text with too little contrast can be hard to read. Low contrast text near to an image with glare may also be hard to read. Various examples of the possible modifications are provided below in conjunction with FIGS. 6A, 6B, 6C, and 6D.

FIG. 6A shows an example of operation 403 and how an appearance optimizer (e.g., appearance optimizer 409A) modifies 427 one or more images based upon the analysis 425 of the spatial metadata for one or more content elements. In this example, the dark image (“pixel/area 1”) to the left of the image with detected glare (“pixel/area 2”) will be modified as shown in FIG. 6A to adjust that image in view of the detected glare in the image on the right side of the displayable unit. Operation 403 determines the distance between the two images that have a large difference in maximum luminance; the operation 403 can also receive input about the viewing conditions (which may include the field of view of the viewer) as shown in FIG. 6A. Based on the detected glare in the image on the right, the maximum luminance of the dark image on the left is increased and the chroma or color saturation is increased. These adjustments can be performed by an appearance optimizer as shown in FIG. 5B. There are techniques known in the art to detect glare, such as glare models that are known in the art. See, for example, https://www.lrc.rpi.edu/programs/Transportation/pdf/glareCalculation.pdf. These glare models can use a deBoer scale to classify the glare (from just noticeable to unbearable). These glare models can allow a designer of the displayable page to control the perceived impact of glare. For example, the perceived impact of glare can be creatively modified if desired by the content creator. For example, it can be desired to avoid any glare in a rendered image, have some glare or deliberately desire glare (e.g. to create a feeling of discomfort for storytelling).

FIG. 6B shows a flowchart that shows a method that is similar to what is shown in FIG. 6A, except that the method in FIG. 6B can be an optional trim pass method that adjusts an image. Metadata for an optional trim pass can be associated with a content element and used to further adjust the content element beyond what an initial analysis may suggest. In this case, a dark image is adjusted in view of glare that is near the dark image. The dark image is detected 451 near an image with detected glare, and a color volume mapping offset preference is defined 453 to modify the appearance of the dark image.

FIG. 6C shows an example of content element modification before compositing the five content elements 503, 504, 506, 508, and 502 shown in FIG. 6C. The top 3 content elements are each separately modified using a tone mapping (or color volume mapping); in particular, the tone mapping 505 modifies the appearance of the content element 503, the tone mapping 507 modifies the appearance of the content element 504, and the tone mapping 509 modifies the appearance of the content element 506. In each of these modifications, the pixel values are modified in accordance with the analysis of the metadata described above to improve the appearance in the final composited unit which is an HDR canvas 511 with a custom dynamic range. SDR content elements 508 and 502 are mapped into a perceptually quantized (PQ as described in ITU-R Rec. BT.2100) container for display on the HDR canvas using processes that are known in the art. After the modified content elements are composited onto the HDR canvas 511 (in a frame buffer), the displayable unit is displayed on display devices 513 and 515. In another embodiment, the modifications can occur after the content elements are composited onto the canvas of the displayable unit; for example, all of the content elements can be mapped after compositing. In yet another embodiment, the modifications can occur both before compositing and after compositing.

Composited content often includes videos and animations composited with static images and text. Web pages often include videos, text and static images composited together (often from different sources) on the same web page. The videos and animations can have images that change drastically over time (e.g., a night scene in a movie followed by a daylight scene on a bright beach in the movie) or contain image elements that appear or disappear over time or based on a trigger. How the content around the movie on the page appears depends upon both spatial metadata and temporal metadata; moreover, the content in the movie may be modified. The temporal metadata normally changes over time as the video and animations change and can cause the modification of one or more content elements. FIG. 6D shows an example 551 of how spatial and temporal metadata can be used to modify one or more content elements while two videos are played back on a displayable unit over three scenes 553, 555, and 557. The methods described for static pages can be used within each scene to modify the content based on the metadata within each scene. If the video content is Dolby Vision content that uses existing dynamic metadata based on Dolby Vision, this dynamic metadata can be compared against the spatial metadata and adjusted throughout the playback.

In addition, the transition from the temporally local metadata for scene 553 to scene 555 and scene 557 does not have to be abrupt. Instead, in one embodiment, the transition can be gradual or temporally dampened, e.g. by following the time course of adaptation (based on adaptation models for light, dark and chromatic adaptation, which are known in the art). For example, the metadata identified for mapping in scene 553 can be altered by 403 to transition gradually over time to the metadata identified to map in scene 555. This can also help with the optimization and better use of the available color volume of an output display and to avoid signal clipping or crushing or loss of contrast.

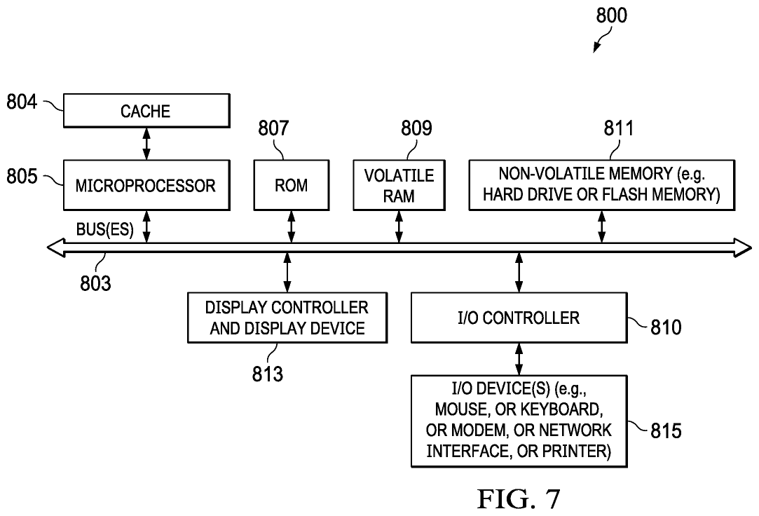

FIG. 7 shows one example of a data processing system 800, which may be used with one or more embodiments described herein. For example, the system 800 may be used to perform any of the methods described herein, such as the methods shown in FIGS. 2A, 2C, 3A, 3B, 4A, 4B, 5A, 5B, 5C, 6A, 6B, 6C and 6D. Such a data processing system can create the metadata and be part of the system shown in FIG. 2B. Further, such a data processing system can be any one of the systems shown in FIG. 1B. Such a system can include a web browser that composites and renders a web page using the metadata described herein. Note that while FIG. 7 illustrates various components of a device, it is not intended to represent any particular architecture or manner of interconnecting the components as such details are not germane to the disclosure. It will also be appreciated that network computers and other data processing systems or other consumer electronic devices, which have fewer components or perhaps more components, may also be used with embodiments of the disclosure. In one embodiment, the data processing system can be a smart phone or other mobile devices.

As shown in FIG. 7, the device 800, which is a form of a data processing system, includes a bus 803 which is coupled to a microprocessor(s) 805 and a ROM (Read Only Memory) 807 and volatile RAM 809 and a non-volatile memory 811. The microprocessor(s) 805 may retrieve the instructions from the memories 807, 809, 811 and execute the instructions to perform operations described above. The microprocessor(s) 805 may contain one or more processing cores. The bus 803 interconnects these various components together and also interconnects these components 805, 807, 809, and 811 to a display controller and display device 813 and to peripheral devices such as input/output (I/O) devices 815 which may be touchscreens, mice, keyboards, modems, network interfaces, printers, one or more cameras, and other devices which are well known in the art. Typically, the input/output devices 815 are coupled to the system through input/output controllers 810. The volatile RAM (Random Access Memory) 809 is typically implemented as dynamic RAM (DRAM), which requires power continually in order to refresh or maintain the data in the memory.

The non-volatile memory 811 is typically a magnetic hard drive or a magnetic optical drive or an optical drive or a DVD RAM or a flash memory or other types of memory systems, which maintain data (e.g., large amounts of data) even after power is removed from the system. Typically, the non-volatile memory 811 will also be a random access memory although this is not required. While FIG. 7 shows that the non-volatile memory 811 is a local device coupled directly to the rest of the components in the data processing system, it will be appreciated that embodiments of the disclosure may utilize a non-volatile memory which is remote from the system, such as a network storage device which is coupled to the data processing system through a network interface such as a modem, an Ethernet interface or a wireless network. The bus 803 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The disclosure also relates to an apparatus for performing the operations described herein. This apparatus may be specially constructed for the required purpose, or it may comprise a general-purpose device selectively activated or reconfigured by a computer program stored in the device. Such a computer program may be stored in a non-transitory computer readable storage medium, such as, but not limited to, any type of disk including floppy disks, optical disks, CD-ROMs, and magnetic-optical disks, DRAM (volatile), flash memory, read-only memories (ROMs), RAMs, EPROMS, EEPROMs, magnetic or optical cards, or any type of media suitable for storing electronic instructions, and each coupled to a device bus.

A machine readable medium includes any mechanism for storing information in a form readable by a machine (e.g., a computer). For example, a non-transitory machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more non-transitory memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)) and then stored in non-transitory memory (e.g., DRAM or flash memory or both) in the client computer.

The preceding detailed descriptions are presented in terms of algorithms and symbolic representations of operations on data bits within a device memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “sending,” “terminating,” “waiting,” “changing,” or the like, refer to the action and processes of a device, or similar electronic computing device, that manipulates and transforms data represented as physical (electronic) quantities within the device's registers and memories into other data similarly represented as physical quantities within the device memories or registers or other such information storage, transmission or display devices.

The processes and displays presented herein are not inherently related to any particular device or other apparatus. Various general-purpose systems may be used with programs in accordance with the teachings herein, or it may prove convenient to construct a more specialized apparatus to perform the operations described. The required structure for a variety of these systems will be evident from the description below. In addition, the disclosure is not described with reference to any particular programming language. It will be appreciated that a variety of programming languages may be used to implement the teachings of the disclosure as described herein.

### Exemplary Embodiments

The following text presents numbered embodiments in claim like format, and it will be understood that these embodiments may be presented as claims in one or more future filings, such as one or more continuation or divisional applications.

Although separate embodiments are described in detail below, however, it is appreciated that these embodiments may be combined or modified, in part or in whole. Moreover, each of these embodiments may also be expressed as machine readable media or data processing systems instead of methods.
Embodiment 1. A method for processing data, the method comprising:
   receiving a set of elements containing content and data representing positions or positioning rules, on a displayable unit, of each of the elements in the set of elements;
   determining one or more types of content in each of the elements;
   generating a set of metadata, from the set of elements, the set of metadata for use in creating composited content from the set of elements on the displayable unit when the composited content is displayed, the set of metadata comprising (1) spatial data about the elements and (2) image metadata about at least some of the elements; and
   storing the generated set of metadata with an association to each of the elements.
Embodiment 2. The method as in Embodiment 1, wherein the displayable unit is one of: (a) a page, sheet, folio, or other unit of content; or (b) a web page; or (c) a portion of or all of a screen of a display device or (d) content generated at least in part by a computer program.
Embodiment 3. The method as in Embodiment 2, wherein the method further comprises:
   transmitting the set of elements and the generated set of metadata in response to a request for the web page, and wherein the data representing positions or positioning rules is contained in a description of the displayable unit in a hypertext markup language.
Embodiment 4. The method as in any one of the previous Embodiments, wherein the one or more types of content comprise at least one of: (a) high dynamic range (HDR) image content; (b) standard dynamic range (SDR) image content; (c) text content; or (d) user interface content for use in receiving inputs from a user.
Embodiment 5. The method as in any one of the previous Embodiments, wherein the spatial data comprises vector based spatial data that defines approximate boundaries on the displayable unit of each of the elements in the set of elements.
Embodiment 6. The method as in any one of the previous Embodiments, wherein the image metadata comprises color volume properties or image statistics for at least some of the elements in the set of elements.
Embodiment 7. The method as in any one of the previous Embodiments, wherein the image statistics comprises one or more of: maximum luminance of an image; diffuse white level and white-point of an image, minimum luminance of an image; mean luminance of an image; or median luminance of an image.
Embodiment 8. The method as in any one of the previous Embodiments, wherein the set of metadata also describes a temporal change of the content over time, and wherein the set of metadata describes a rate of change associated with the temporal change of the content over time, the rate of change indicating a rate, over time, that metadata in the set of metadata changes from one scene to a next scene.
Embodiment 9. The method as in any one of the previous Embodiments, wherein the image metadata comprises data about detected glare or data from which glare is detected in at least one of the elements in the set of elements.
Embodiment 10. The method as in any one of the previous Embodiments, wherein the image metadata comprises a texture abstraction of at least one of the elements in the set of elements.
Embodiment 11. The method as in Embodiment 10, wherein the texture abstraction is derived from a Fourier analysis based representation of the at least one of the elements in the set of elements.
Embodiment 12. The method as in any one of the previous Embodiments, wherein the image metadata comprises a quantized representation of at least one of the elements in the set of elements.
Embodiment 13. The method as in any one of the previous Embodiments, wherein an application programing interface (API) is used to cause the generation of the set of metadata, the API linking a metadata generation component in a data processing system with a web page creation software.
Embodiment 14. The method as in any one of the Embodiments 9-13, wherein the detected glare is classified as one of disability glare or discomfort glare.
Embodiment 15. The method as in any one of the previous Embodiments, wherein the set of metadata is stored in a scalable vector graphics format.
Embodiment 16. A method for processing data, the method comprising:
   receiving a set of metadata for use in creating composited content from a set of elements which are to be composited together for display in a displayable unit, the set of metadata comprising (1) spatial data about the elements and (2) image metadata about at least some of the elements;
   processing the set of metadata to determine how to modify one or more of the elements based on the set of metadata;
   modifying one or more of the elements based on the set of metadata; and
   rendering the composited content with the modified one or more elements to display the displayable unit on a display device.
Embodiment 17. The method as in Embodiment 16, wherein the displayable unit is one of: (a) a page, sheet, folio, or other unit of content; or (b) a web page; or (c) a portion of or all of a screen of a display device or (d) content generated at least in part by a computer program.
Embodiment 18. The method as in Embodiment 17, wherein the receiving is in response to a request for the web page and the set of metadata is received by a web browser, and wherein at least a portion of the modifying occurs after the content is composited.
Embodiment 19. The method as in any one of Embodiments 16-18, wherein the composited content comprises at least one of: (a) high dynamic range (HDR) image content; (b) standard dynamic range (SDR) image content; (c) text content; or (d) user interface content for use in receiving inputs from a user.
Embodiment 20. The method as in any one of Embodiments 16-19, wherein the modifying is based at least in part on the spatial data and the image metadata.
Embodiment 21. The method as in any one of Embodiments 16-20, wherein the spatial data comprises vector based spatial data that defines approximate boundaries on the displayable unit of each of the elements in the set of elements, and the approximate boundaries are used to compute a distance between at least two elements in the set of elements.
Embodiment 22. The method as in any one of Embodiments 16-21, wherein the image metadata comprises color volume properties or image statistics for least some of the elements in the set of elements.
Embodiment 23. The method as in any one of Embodiments 16-22, wherein the image statistics comprises one or more of: maximum luminance of an image; minimum luminance of an image; mean luminance of an image; or median luminance of an image.
Embodiment 24. The method as in any one of Embodiments 16-23, wherein the set of metadata also describes a temporal change of the content over time, and wherein the set of metadata describes a rate of change associated with the temporal change of the content over time, the rate of change indicating a rate, over time, that the metadata in the set of metadata changes from one scene to a next scene.
Embodiment 25. The method as in any one of Embodiments 16-24, wherein the image metadata comprises data about detected glare or data from which glare is detected in at least one of the elements in the set of elements and wherein the modifying reduces the detected glare.
Embodiment 26. The method as in any one of Embodiments 16-25 wherein the method further comprises:
determining a distance, on the displayable unit, between a first element and a second element in the set of elements and determining a difference in an image data statistic between the first element and the second element;
modifying one or both of the first element or the second element based on the determined distance and the determined difference.
Embodiment 27. The method as in any one of Embodiments 16-26, wherein the modifying of the first or second element occurs either before compositing the content or after compositing the content.
Embodiment 28. The method as in any one of Embodiments 16-27, wherein the set of metadata is received in a scalable vector graphics format.
Embodiment 29. The method as in any one of Embodiments 16-28, wherein the image metadata comprises a texture abstraction of at least one of the elements in the set of elements.
Embodiment 30. The method as in in any one of Embodiments 16-29, wherein the modifying takes into account one or more of: (a) an on screen and off screen status of content in the displayable unit; (b) display devices used to display the content in the displayable unit; (c) an ambient viewing environment surrounding a display device that displays the displayable unit; or (d) a viewing distance of a viewer of the displayable unit.
Embodiment 31. A non-transitory machine readable medium storing executable program instructions which when executed by one or more data processing systems cause the one or more data processing systems to perform a method as in any one of Embodiments 1-30.
Embodiment 32. A data processing system configured to perform a method as in any one of Embodiments 1-30.

1. A method for processing data, the method comprising:
receiving a set of elements containing content to be composited into a displayable unit and data representing positions or positioning rules in the displayable unit of each of the elements in the set of elements, the set of elements comprising all content to be displayed on the displayable unit;
determining one or more types of content in each of the elements;
generating a set of metadata, from the set of elements, the set of metadata for use in creating composited content from the set of elements on the displayable unit, the set of metadata comprising (1) spatial data about each of the elements and (2) image metadata about at least some of the elements, wherein the spatial data comprises vector based spatial data that defines approximate boundaries on the displayable unit of each of the elements in the set of elements, and wherein the image metadata comprises color volume properties or image statistics for at least some of the elements in the set of elements; and wherein the image statistics comprises one or more of: maximum luminance of an image; diffuse white level and white-point of an image, minimum luminance of an image; mean luminance of an image; or median luminance of an image; and
storing the generated set of metadata with an association to each of the elements for use during composition of the set of elements on the displayable unit.

2. The method as in claim 1, wherein the displayable unit is one of: (a) a page, sheet, folio, or other unit of content; or (b) a web page; or (c) a portion of or all of a screen of a display device or (d) content generated at least in part by a computer program.

3. The method as in claim 2, wherein the method further comprises:
transmitting the set of elements and the generated set of metadata in response to a request for the web page, and wherein the data representing positions or positioning rules is contained in a description of the displayable unit in a hypertext markup language.

4. The method of claim 1, wherein the one or more types of content comprise at least one of: (a) high dynamic range (HDR) image content; (b) standard dynamic range (SDR) image content; (c) text content; or (d) user interface content for use in receiving inputs from a user.

5. The method as in claim 1, wherein the set of metadata also describes a temporal change of the content over time, and wherein the set of metadata describes a rate of change associated with the temporal change of the content over time, the rate of change indicating a rate, over time, that metadata in the set of metadata changes from one scene to a next scene.

6. The method as in claim 1, wherein the image metadata comprises data about detected glare or data from which glare is detected in at least one of the elements in the set of elements, and wherein the detected glare is classified as one of disability glare or discomfort glare.

7. The method as in claim 1, wherein the image metadata comprises a texture abstraction of at least one of the elements in the set of elements.

8. The method as in claim 7, wherein the texture abstraction is derived from a Fourier analysis based representation of the at least one of the elements in the set of elements.

9. The method as in claim 1, wherein the image metadata comprises a quantized representation of at least one of the elements in the set of elements.

10. The method as in claim 1, wherein an application programing interface (API) is used to cause the generation of the set of metadata, the API linking a metadata generation component in a data processing system with a web page creation software.

11. The method as in claim 1, wherein the set of metadata is stored in a scalable vector graphics format.

12. A non-transitory machine readable medium storing executable program instructions which when executed by one or more data processing systems cause the one or more data processing systems to perform a method as in claim 1.

13. A data processing system configured to perform a method as in claim 1.
